(19) United States
(12) Patent Application Publication
(10) Pub. No.: US 2026/0342373 A1
(43) Pub. Date: Oct. 29, 2026

(54) MOBILE PHONE DOCKING DEVICE

(71) Applicant: Ted Chester, Boise, ID (US)

(72) Inventor: Ted Chester, Boise, ID (US)

(21) Appl. No.: 19/186,826

(22) Filed: Apr. 23, 2025

(51) Int. Cl. H04B 1/3877; H02J 7/70; H02J 7/80

(52) U.S. Cl. CPC H04B 1/3877; H02J 7/731; H02J 7/80

(57) ABSTRACT

A mobile phone docking device includes a smartphone which is in wireless communication with an extrinsic communication network to place and receive phone calls. A docking station is included which has a handset which can be manipulated by a user for participating in a phone call. Each of the housing and the handset has the ornamental appearance of a land line telephone. A charging unit is attached to the base to wirelessly charge a rechargeable battery in the smartphone. A communication unit is in wireless communication with the smartphone when the smartphone is positioned in the charging unit thereby enabling the user to employ the handset to either place or receive a phone call via the smartphone.

### (b) CROSS-REFERENCE TO RELATED APPLICATIONS

Not Applicable

### (C) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to docking devices and more particularly pertains to a new docking device for wirelessly charging a smartphone and enabling a handset of a rotary phone to be employed to place or receive a phone call from the smartphone. The device includes a base and a charging unit attached to the base upon which the smartphone can be placed for wirelessly charging the smartphone. The device includes housing that is attachable to the base and a handset attached to the housing and a communication unit integrated into the housing. The communication unit is in wireless communication with the smartphone when the smartphone is being wirelessly charged to enable the handset to be employed to place or receive a phone call via the smartphone.

### (2) Description of Related Art Including Information Disclosed Under 37 CFR 1.97 and 1.98

The prior art relates to docking devices including a variety of mobile device docking stations that each at least includes a docking port which is recessed into a housing for insertably receiving a mobile device for charging the mobile device and a communication device that includes a housing which has a slot for insertably receiving a mobile device and a handset attached to the housing that is placed in communication with the mobile device for receiving an audio signal from the mobile device and an ornamental design for a smartphone docking station that includes a housing structured to have the ornamental appearance of a vintage phone and a charging port being recessed into the housing for receiving a mobile device. In no instance does the prior art disclose a mobile phone docking device that includes a base and a charging unit attached to the base for wirelessly charging a mobile phone when the mobile phone is placed on the charging unit and a housing that is removably attachable to the base which includes a handset and a communication unit integrated into the housing which is placed in wireless communication with the mobile device for placing or receiving a phone call on the handset via the mobile device.

### (h) BRIEF SUMMARY OF THE INVENTION

An embodiment of the disclosure meets the needs presented above by generally comprising a smartphone which is in wireless communication with an extrinsic communication network to place and receive phone calls. A docking station is included which has a handset which can be manipulated by a user for participating in a phone call. Each of the housing and the handset has the ornamental appearance of a land line telephone. A charging unit is attached to the base to wirelessly charge a rechargeable battery in the smartphone. A communication unit is in wireless communication with the smartphone when the smartphone is positioned in the charging unit thereby enabling the user to employ the handset to either place or receive a phone call via the smartphone.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a mobile phone docking device according to an embodiment of the disclosure.

FIG. 2 is a front phantom view of an embodiment of the disclosure.

FIG. 3 is a bottom phantom view of an embodiment of the disclosure.

FIG. 4 is a left side exploded view of an embodiment of the disclosure.

FIG. 5 is a schematic view of an embodiment of the disclosure.

FIG. 6 is a front view of an alternative embodiment of the disclosure.

FIG. 7 is a front perspective view of an alternative embodiment of the disclosure.

FIG. 8 is a side perspective view of an alternative embodiment of the disclosure.

### (J) DETAILED DESCRIPTION OF THE INVENTION

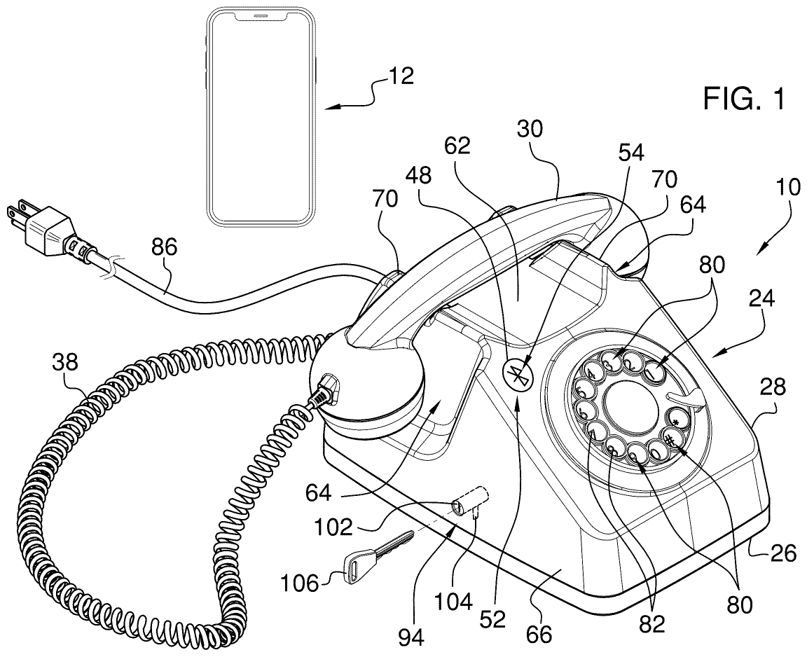

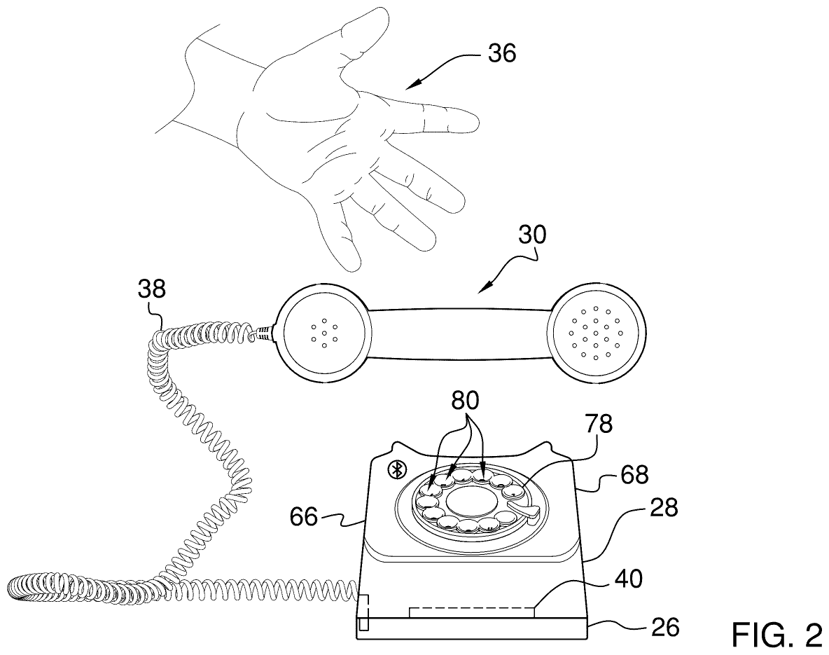

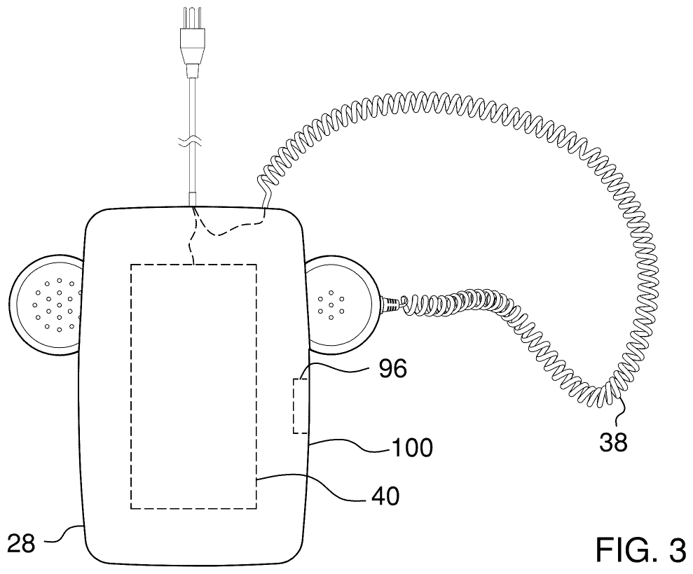

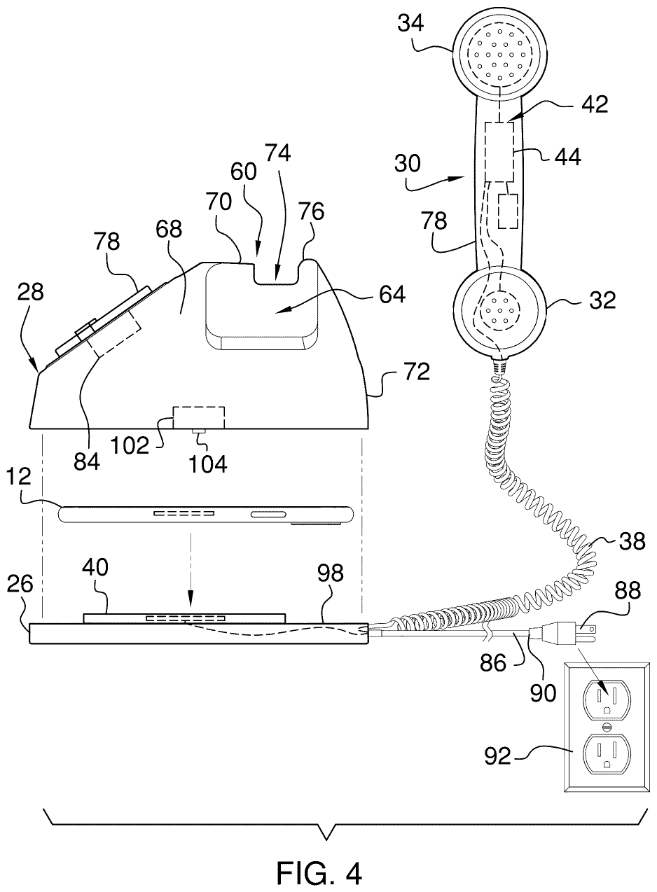

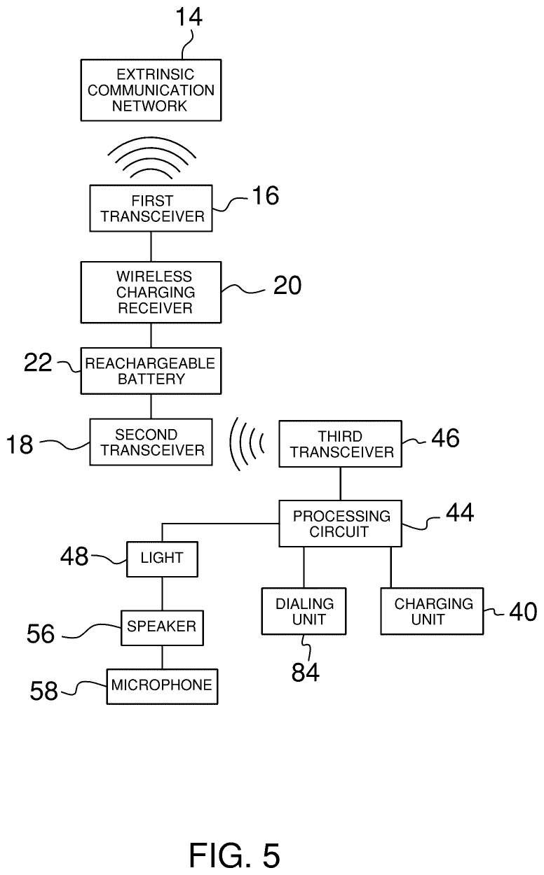

With reference now to the drawings, and in particular to FIGS. 1 through 8 thereof, a new docking device embodying the principles and concepts of an embodiment of the disclosure and generally designated by the reference numeral 10 will be described.

As best illustrated in FIGS. 1 through 8, the mobile phone docking device 10 generally comprises a smartphone 12 which is in wireless communication with an extrinsic communication network 14 thereby enabling the smartphone 12 to place and receive phone calls. The extrinsic communication network 14 may comprise a cellular phone network or the internet or any other type of wireless global communication network. The smartphone 12 has a first transceiver 16 which is in wireless communication with the extrinsic communication network 14 and the smartphone 12 has a second transceiver 18. The first transceiver 16 may comprise a radio frequency transceiver or the like and the first transceiver 16 may employ cellular phone communication protocols. The second transceiver 18 may comprise a radio frequency transceiver or the like and the second transceiver 18 may employ Bluetooth communication protocols. Additionally, the smartphone 12 has a wireless charging receiver 20 and a rechargeable battery 22 which is electrically coupled to the wireless charging receiver 20 for charging the rechargeable battery 22.

A docking station 24 is included which comprises a base 26 and a housing 28 that is removably attachable to the base 26 and a handset 30. The handset 30 has a mouthpiece 32 and an earpiece 34 thereby enabling the handset 30 to be manipulated by a user 36 for participating in a phone call. Each of the housing 28 and the handset 30 is strategically structured to have the ornamental appearance of a land line telephone thereby enabling the docking station 24 to appear as a vintage telephone for the user 36. In this way the housing 28 enhances the user's 36 experience of participating in a phone call. Additionally, the docking station 24 includes a cord 38 extending between the mouthpiece 32 and the base 26 and the cord 38 is comprised of an electrically conductive material.

The docking station 24 includes a charging unit 40 that is attached to the base 26 thereby enabling the smartphone 12 to be placed on the charging unit 40. The charging unit 40 is in wireless communication with the wireless charging receiver 20 in the smartphone 12 when the smartphone 12 is placed on the charging unit 40 thereby enabling the charging unit 40 to wirelessly charge the rechargeable battery 22 in the smartphone 12. Furthermore, the charging unit 40 may comprise a wireless battery charger of any conventional design that is commonly employed for wirelessly charging smartphone batteries. The docking station 24 includes a communication unit 42 which is in wireless communication with the smartphone 12 when the smartphone 12 is positioned in the charging unit 40. In this way the communication unit 42 is enabled to be in wireless communication with the extrinsic communication network 14. Furthermore, the handset 30 is in communication with the communication unit 42 to enable the user 36 to employ the handset 30 to either place or receive a phone call via the smartphone 12. In this way the user 36 can enjoy the combined experiences of employing a vintage telephone and employing modern smartphone 12 technology. Additionally, the communication unit 42 is actuated when the smartphone 12 is positioned on the charging unit 40.

The communication unit 42 comprises a processing circuit 44 which is positioned in the handset 30 and the processing circuit 44 receives a charge input. The processing circuit 44 is electrically coupled to the cord 38 which extends between the mouthpiece 32 of the handset 30 and the base 26. The charging unit 40 is electrically coupled to the processing circuit 44 and the processing circuit 44 receives the charge input when the charging unit 40 is in wireless communication with the wireless charging receiver 20 in the smartphone 12. The communication unit 42 includes a third transceiver 46 which is positioned in the handset 30 and the third transceiver 46 is electrically coupled to the processing circuit 44. The third transceiver 46 is placed in wireless communication with the second transceiver 18 in the smartphone 12 when the processing circuit 44 receives the charge input. In this way the third transceiver 46 is placed in wireless communication with the extrinsic communication network 14 to facilitate the communication unit 42 to place or receive a phone call over the extrinsic communication network 14.

The communication unit 42 includes a light 48 which is attached to the front wall 50 of the housing 28 to emit visible light outwardly from the housing 28 and the light 48 is electrically coupled to the processing circuit 44. The light 48 is turned on when the processing circuit 44 receives the charge input to visually alert the user 36 that the third transceiver 46 is in communication with the extrinsic communication network 14. Additionally, the light 48 may comprise a light emitting diode or the like and the light 48 includes a lens 52, upon which indicia 54 are applied comprising the Bluetooth communication symbol.

The communication unit 42 includes a speaker 56 which is positioned in the earpiece 34 of the handset 30 to emit audible sounds outwardly through the earpiece 34. The speaker 56 is electrically coupled to the processing circuit 44 to emit the audible sounds of a person that the user 36 is speaking to via the phone call. The communication unit 42 includes a microphone 58 which is positioned in the mouthpiece 32 of the handset 30 to capture audible sounds. The microphone 58 is electrically coupled to the processing circuit 44 to communicate the audible sounds of the user 36 speaking to the person via the phone call.

The housing 28 has a handset cradle 60 which is integrated into a top wall 62 of the housing 28. The handset cradle 60 comprises a pair of recesses 64 each extending into a respective one of a first lateral wall 66 and a second lateral wall 68 of the housing 28 and a pair of ridges 70 each extending upwardly from the top wall 62. Each of the pair of ridges 70 is elongated along an axis extending between a front wall 50 and a back wall 72 of the housing 28 and each of the pair of ridges 70 is positioned adjacent to a respective one of the pair of recesses 64. Furthermore, each of the pair of ridges 70 has a depression 74 extending downwardly in a top surface 76 of the ridges 70. The depression 74 in the top surface 76 of each of the pair of ridges 70 accommodates a handle 78 of the handset 30 having each of the mouthpiece 32 and the earpiece 34 being positioned in a respective one of the pair of recesses 64. The front wall 50 of the housing 28 is oriented at a downward slope with respect to the top wall 62 of the housing 28.

The housing 28 includes a rotary dial 78 which is rotatably attached to the front wall 50 of the housing 28. The rotary dial 78 has a plurality of finger holes 80 which are evenly spaced apart from each other and are distributed around a substantial circumference of the rotary dial 78. In this way the rotary dial 78 can be employed for dialing a phone number in the convention of rotary phones. Indicia 82 are applied to the front wall 50 and the indicia 82 on the front wall 50 comprise a plurality of numbers each aligned with a respective one of the plurality of finger holes 80 in the rotary dial 78. In this way the rotary dial 78 and the indicia 82 on the front wall 50 enhance the ornamental appearance of the housing 28 with respect to the land line telephone. The communication unit 42 includes a dialing unit 84 that is in communication with the rotary dial 78 for converting the rotation of the rotary dial 78 into digital information that is communicated to the smartphone 12 for dialing the phone number with the smartphone 12.

The charging unit 40 is electrically coupled to the processing circuit 44 of the communication unit 42. Furthermore, the processing circuit 44 receives the charge input when the charging unit 40 is in wireless communication with the wireless charging receiver 20 in the smartphone 12. The charging unit 40 includes a power cord 86 which is coupled to and extends away from the base 26. The power cord 86 is electrically coupled to the charging unit 40 and the power cord 86 has a male plug 88 which is electrically coupled to a distal end 90 of the power cord 86. Furthermore, the male plug 88 can be electrically mated to a power source 92 comprising a female electrical outlet.

A lock 94 is movably integrated into the docking station 24 and the lock 94 secures the housing 28 to the base 26 when the lock 94 is manipulated into a locked position. Conversely, the lock 94 enables the housing 28 to be removed from the base 26 when the lock 94 is manipulated into an unlocked position. The lock 94 includes a lock engagement 96 which is integrated into a top surface 98 of the base 26 at a point located adjacent to a lateral edge 100 of the base 26. The lock 94 includes a key lock 102 which is rotatably integrated into the first lateral wall 66 of the housing 28 of the docking station 24. The key lock 102 includes a finger 104 which engages the lock engagement 96 when the key lock 102 is rotated in a first direction. Conversely, the finger 104 is disengaged from the lock engagement 96 when the key lock 102 is rotated in a second direction. The lock 94 includes a key 106 which is insertable into the key lock 102 to enable the key lock 102 to be rotated in the first direction or the second direction. In this way the key lock 102 inhibits an unauthorized person from accessing the smartphone 12 when the smartphone 12 is positioned on the charging unit 40.

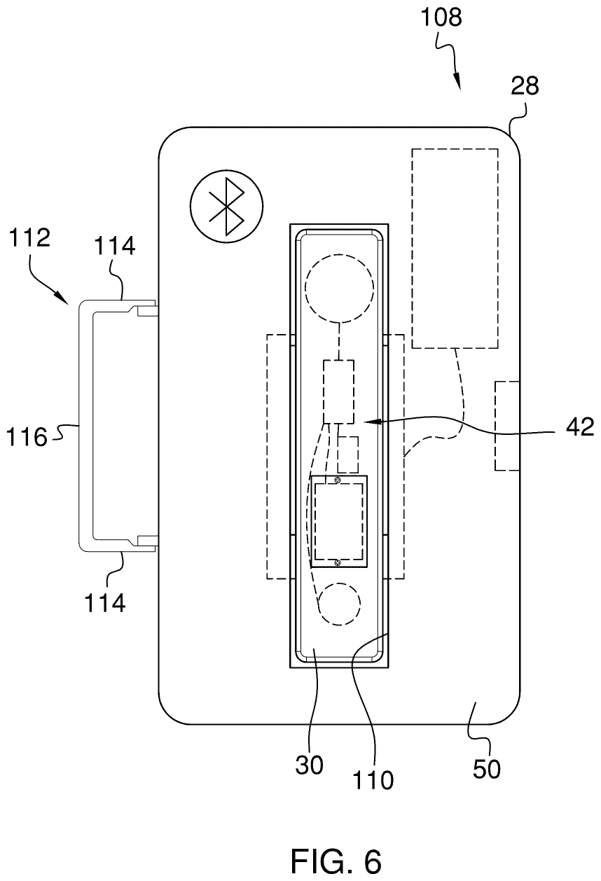

In an alternative embodiment 108 as shown in FIG. 6, the housing 28 has a rectangular shape and the housing 28 has a depression 110 which is integrated into the front wall 50 of the housing 28. Furthermore, the depression 110 is elongated along the axis extending between the front wall 50 and the back wall 72 of the housing 28 and the depression 110 is centrally located on the front wall 50. A handle 112 is included which comprises a pair of outward members 114 each pivotally coupled to the first lateral wall 66 of the housing 28 and a central member 116 extending between the pair of outward members 114. The central member 116 is gripped for carrying the housing 28 thereby enabling the parent to encumber their child with the inconvenience of carrying the housing 28. Furthermore, the handset 30 is removably fit-able into the depression 110 for storing the handset 30 and the communication unit 42 is integrated into the handset 30.

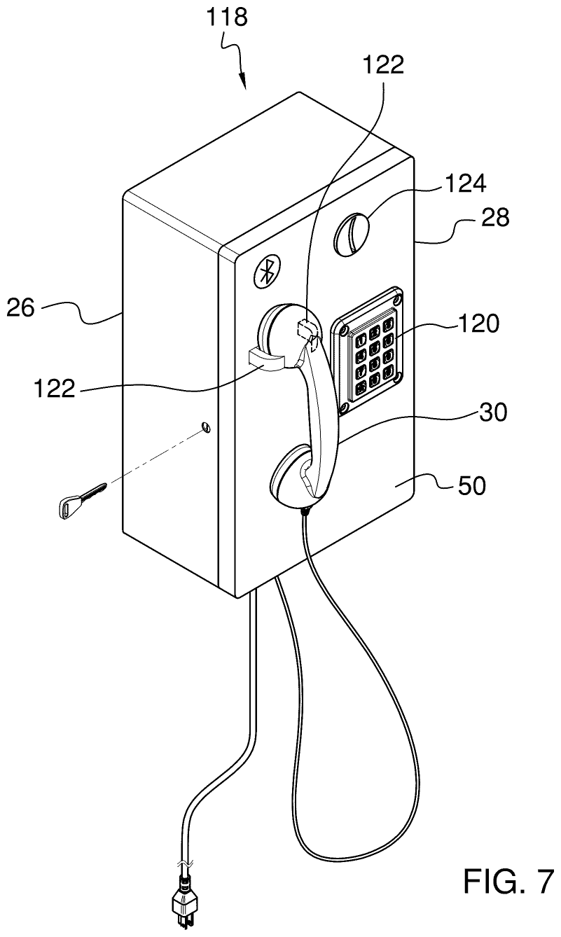

In an alternative embodiment 118 as shown in FIG. 7, each of the base 26 and the housing 28 has a rectangular shape and the housing 28 includes a key pad 120 which is disposed on the front wall 50 of the housing 28. The key pad 120 is electrically coupled to the processing circuit 44 for dialing a phone number. The handset cradle 60 comprises a pair of horns 122 each extending away from the front wall 50 of the housing 28. The pair of horns 122 are spaced apart from each other to enable the earpiece 34 of the handset 30 to be positioned between the pair of horns 122 for suspending the handset 30 from the handset cradle 60. Additionally, a coin slot 124 may be integrated into the front wall 50 of the housing 28 to charge the user 36 a fee for employing the communication unit 42.

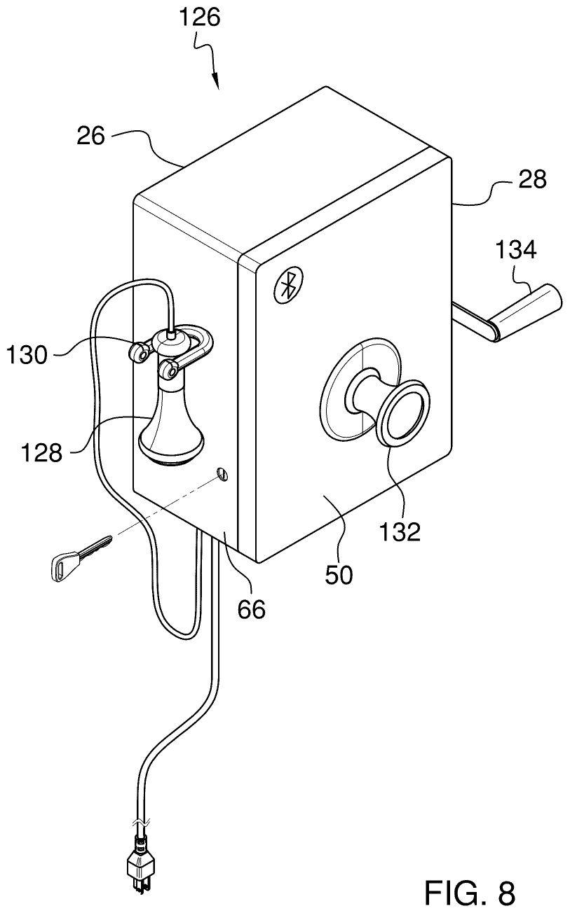

In an alternative embodiment 126 as shown in FIG. 8, each of the base 26 and the housing 28 has a rectangular shape. The handset 30 comprises a horn 128 which can be gripped by the user 36 for pointing the horn 128 at one of the user's 36 ears and the speaker 56 is positioned in the horn 128. The handset cradle 60 comprises a yoke 130 extending away from the first lateral wall 66 of the housing 28 thereby enabling the horn 128 to be suspended on the yoke 130. Additionally, the communication unit 42 includes a horn 132 which is coupled to and extends forwardly from the front wall 50 of the housing 28 thereby enabling the horn 132 on the front wall 50 to be spoken into by the user 36. Furthermore, the microphone 58 is positioned in the horn 132 on the front wall 50 of the housing 28. The communication unit 42 includes a hand crank 134 which is rotatably attached to the second lateral wall 68 of the housing 28 and which must be continuously rotated by the user 36 to keep the communication unit 42 actuated. In this way the hand crank 134 can be employed as a type of punishment for a child, for example that has refused to obey their parent's rules regarding the use of their smartphone 12.

In use, the smartphone 12 is placed on the charging unit 40 to charge the rechargeable battery 22 in the smartphone 12. The communication unit 42 is actuated once the charging unit 40 is placed in wireless communication with the wireless charging unit 40 in the smartphone 12. The housing 28 is positioned on the base 26 and the key is employed to lock 94 the housing 28 to the base 26 thereby securing the smartphone 12 in the housing 28. Furthermore, securing the smartphone 12 in the housing 28 inhibits access to social media via the smartphone 12 thereby enabling a parent to monitor the social media use of their children, for example. The rotary dial 78 is employed to dial a phone number to place a phone call via the smartphone 12 and the handset 30 is employed for either making or receiving the phone call. In this way the handset 30 and the rotary dial 78 enables the user 36 to enjoy the nostalgic experience of participating in a phone call on a vintage rotary phone.

In each of the alternative embodiments 108, 126 shown in FIGS. 6 and 8, the housing 28 is structured to be bulky and inconvenient to carry when storing the smartphone 12 within the housing 28 is intended to be a form of punishment imposed by a parent on a child, for example. The alternative embodiment 108 in FIG. 6 requires the user 36 to carry the housing 28 in the convention of a vintage car phone to place inconvenience on the user 36. The alternative embodiment 126 in FIG. 8 requires the user 36 to continuously crank the hand crank 134 in order to be able to place or receive a phone call thereby encumbering the user 36 as a form of punishment. The alternative embodiment 118 shown in FIG. 7 can be placed in a public location, such as a restaurant for example, to enable the communication unit 42 to be employed by a patron who has paid a fee in the coin slot 124.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A mobile phone docking device for charging a mobile phone, said device comprising:
a smartphone being in wireless communication with an extrinsic communication network wherein said smartphone is configured to place and receive phone calls;
a docking station comprising a base and a housing being removably attachable to said base and a handset, said handset having a mouthpiece and an earpiece wherein said handset is configured to be manipulated by a user for participating in a phone call, each of said housing and said handset being strategically structured to have the ornamental appearance of a land line telephone wherein said docking station is configured to appear as a vintage telephone for a user thereby enhancing the user's experience of participating in a phone call;
wherein said docking station includes a charging unit being attached to said base thereby enabling said smartphone to be placed on said charging unit, said charging unit being in wireless communication with said wireless charging receiver in said smartphone when said smartphone is placed on said charging unit thereby enabling said charging unit to wirelessly charge said rechargeable battery in said smartphone;
wherein said docking station includes a communication unit being in wireless communication with said smartphone when said smartphone is positioned in said charging unit thereby enabling said communication unit to be in wireless communication with said extrinsic communication network, said handset being in communication with said communication unit wherein said handset is configured to enable the user to employ said handset to either place or receive a phone call via said smartphone, said communication unit being actuated when said smart phone is positioned on said charging unit; and
a lock being movably integrated into said docking station, said lock securing said housing to said base when said lock is manipulated into a locked position, said lock enabling said housing to be removed from said base when said lock is manipulated into an unlocked position.

2. The device according to claim 1, wherein:
said docking station includes a cord extending between said mouthpiece and said housing;
said smartphone has a first transceiver being in wireless communication with said extrinsic communication network;
said smartphone has a second transceiver;
said communication unit includes a processing circuit being positioned in said housing;
said processing circuit receives a charge input;
said processing circuit is electrically coupled to said cord which extends between said mouthpiece of said handset and said housing;
said communication unit includes a third transceiver being positioned in said housing;
said third transceiver is electrically coupled to said processing circuit;
said third transceiver is placed in wireless communication with said second transceiver in said smartphone when said processing circuit receives said charge input thereby enabling said third transceiver to be in wireless communication with said extrinsic communication network wherein said third transceiver is configured to place or receive a phone call over said extrinsic communication network;
a light being attached to said front wall of said housing wherein said light is configured to emit visible light outwardly from said housing;
said light is electrically coupled to said processing circuit; and
said light is turned on when said processing circuit receives said charge input wherein said light is configured to visually alert the user that said third transceiver is in communication with said extrinsic communication network.

3. The device according to claim 2, wherein:
said communication unit includes a speaker being positioned in said earpiece of said handset wherein said speaker is configured to emit audible sounds outwardly through said earpiece;
said speaker is electrically coupled to cord thereby placing said speaker in electrical communication with said processing circuit wherein said speaker is configured to emit the audible sounds of a person that the user is speaking to via the phone call;
said communication unit includes a microphone being positioned in said mouthpiece of said handset wherein said microphone is configured to capture audible sounds; and
said microphone is electrically coupled to cord thereby placing said microphone in electrical communication with said processing circuit wherein said microphone is configured to communicate the audible sounds of the user speaking to the person via the phone call.

4. The device according to claim 1, wherein:
said housing has a handset cradle being integrated into a top wall of said housing;
said handset cradle comprises a pair of recesses each extending into a respective one of a first lateral wall and a second lateral wall of said housing and a pair of ridges each extending upwardly from said top wall;
each of said pair of ridges is elongated along an axis extending between a front wall and a back wall of said housing;
each of said pair of ridges is positioned adjacent to a respective one of said pair of recesses;
each of said pair of ridges has a depression extending downwardly in a top surface of said ridges; and
said depression in said top surface of each of said pair of ridges accommodates a handle of said handset having each of said mouthpiece and said earpiece being positioned in a respective one of said pair of recesses.

5. The device according to claim 1, wherein:
said housing includes a rotary dial being rotatably attached to a front wall of said housing;
said rotary dial has a plurality of finger holes being evenly spaced apart from each other and being distributed around a substantial circumference of said rotary dial;
said housing having indicia being applied to said front wall; and
said indicia on said front wall comprise a plurality of numbers each being aligned with a respective one of said plurality of finger holes in said rotary dial thereby enabling said rotary dial to enhance said ornamental appearance of said housing with respect to the land line telephone.

6. The device according to claim 2, wherein:
said smartphone has a wireless charging receiver and a rechargeable battery being electrically coupled to said wireless charging receiver for charging said rechargeable battery;
said charging unit is electrically coupled to said processing circuit of said communication unit; and
said processing circuit receives said charge input when said charging unit is in wireless communication with said wireless charging receiver in said smartphone.

7. The device according to claim 1, wherein said charging unit includes a power cord being coupled to and extending away from said base;
said power cord is electrically coupled to said charging unit; and
said power cord has a male plug being electrically coupled to a distal end of said power cord wherein said male plug is configured to be electrically mated to a power source comprising a female electrical outlet.

8. The device according to claim 1, wherein:
said lock includes a lock engagement being integrated into a top surface of said base at a point located adjacent to a lateral edge of said base;
said lock includes a key lock being rotatably integrated into a first lateral wall of said housing of said docking station;
said key lock includes a finger which engages said lock engagement when said key lock is rotated in a first direction;
said finger is disengaged from said lock engagement when said key lock is rotated in a second direction; and
said lock includes a key being insertable into said key lock to enable said key lock to be rotated in said first direction or said second direction wherein said key lock is configured to inhibit an unauthorized person from accessing said smartphone when said smartphone is positioned on said charging unit.

9. A mobile phone docking device for charging a mobile phone, said device comprising:
a smartphone being in wireless communication with an extrinsic communication network wherein said smartphone is configured to place and receive phone calls, said smartphone having a first transceiver being in wireless communication with said extrinsic communication network, said smartphone having a second transceiver, said smartphone having a wireless charging receiver and a rechargeable battery being electrically coupled to said wireless charging receiver for charging said rechargeable battery;
a docking station comprising a base and a housing being removably attachable to said base and a handset, said handset having a mouthpiece and an earpiece wherein said handset is configured to be manipulated by a user for participating in a phone call, each of said housing and said handset being strategically structured to have the ornamental appearance of a land line telephone wherein said docking station is configured to appear as a vintage telephone for a user thereby enhancing the user's experience of participating in a phone call, said docking station includes a cord extending between said mouthpiece and said housing;
wherein said docking station includes a charging unit being attached to said base thereby enabling said smartphone to be placed on said charging unit, said charging unit being in wireless communication with said wireless charging receiver in said smartphone when said smartphone is placed on said charging unit thereby enabling said charging unit to wirelessly charge said rechargeable battery in said smartphone, said charging unit including a power cord being coupled to and extending away from said base, said power cord being electrically coupled to said charging unit, said power cord having a male plug being electrically coupled to a distal end of said power cord wherein said male plug is configured to be electrically mated to a power source comprising a female electrical outlet;
wherein said docking station includes a communication unit being in wireless communication with said smartphone when said smartphone is positioned in said charging unit thereby enabling said communication unit to be in wireless communication with said extrinsic communication network, said handset being in communication with said communication unit wherein said handset is configured to enable the user to employ said handset to either place or receive a phone call via said smartphone, said communication unit comprising:
a processing circuit being positioned in said housing, said processing circuit receiving a charge input, said processing circuit being electrically coupled to said cord which extends between said mouthpiece of said handset and said housing, said charging unit being electrically coupled to said processing circuit, said processing circuit receiving said charge input when said charging unit is in wireless communication with said wireless charging receiver in said smartphone;
a third transceiver being positioned in said housing, said third transceiver being electrically coupled to said processing circuit, said third transceiver being placed in wireless communication with said second transceiver in said smartphone when said processing circuit receives said charge input thereby enabling said third transceiver to be in wireless communication with said extrinsic communication network wherein said third transceiver is configured to place or receive a phone call over said extrinsic communication network;
a light being attached to said front wall of said housing wherein said light is configured to emit visible light outwardly from said housing, said light being electrically coupled to said processing circuit, said light being turned on when said processing circuit receives said charge input wherein said light is configured to visually alert the user that said third transceiver is in communication with said extrinsic communication network;
a speaker being positioned in said earpiece of said handset wherein said speaker is configured to emit audible sounds outwardly through said earpiece, said speaker being electrically coupled to cord thereby placing said speaker in electrical communication with said processing circuit wherein said speaker is configured to emit the audible sounds of a person that the user is speaking to via the phone call; and
a microphone being positioned in said mouthpiece of said handset wherein said microphone is configured to capture audible sounds, said microphone being electrically coupled to cord thereby placing said microphone in electrical communication with said processing circuit wherein said microphone is configured to communicate the audible sounds of the user speaking to the person via the phone call;
wherein said housing has a handset cradle being integrated into a top wall of said housing, said handset cradle comprising a pair of recesses each extending into a respective one of a first lateral wall and a second lateral wall of said housing and a pair of ridges each extending upwardly from said top wall, each of said pair of ridges being elongated along an axis extending between a front wall and a back wall of said housing, each of said pair of ridges being positioned adjacent to a respective one of said pair of recesses, each of said pair of ridges having a depression extending downwardly in a top surface of said ridges, said depression in said top surface of each of said pair of ridges accommodating a handle of said handset having each of said mouthpiece and said earpiece being positioned in a respective one of said pair of recesses;
wherein said housing includes a rotary dial being rotatably attached to said front wall of said housing, said rotary dial having a plurality of finger holes being evenly spaced apart from each other and being distributed around a substantial circumference of said rotary dial, said housing having indicia being applied to said front wall, said indicia on said front wall comprising a plurality of numbers each being aligned with a respective one of said plurality of finger holes in said rotary dial thereby enabling said rotary dial to enhance said ornamental appearance of said housing with respect to the land line telephone;
wherein said docking station includes a charging unit being attached to said base thereby enabling said smartphone to be placed on said charging unit, said charging unit being in wireless communication with said wireless charging receiver in said smartphone when said smartphone is placed on said charging unit thereby enabling said charging unit to wirelessly charge said rechargeable battery in said smartphone, said communication unit being actuated when said smart phone is positioned on said charging unit,
a lock being movably integrated into said docking station, said lock securing said housing to said base when said lock is manipulated into a locked position, said lock enabling said housing to be removed from said base when said lock is manipulated into an unlocked position, said lock including:
a lock engagement being integrated into a top surface of said base at a point located adjacent to a lateral edge of said base;
a key lock being rotatably integrated into said first lateral wall of said housing of said docking station, said key lock including a finger which engages said lock engagement when said key lock is rotated in a first direction, said finger being disengaged from said lock engagement when said key lock is rotated in a second direction; and
a key being insertable into said key lock to enable said key lock to be rotated in said first direction or said second direction wherein said key lock is configured to inhibit an unauthorized person from accessing said smartphone when said smartphone is positioned on said charging unit.

10. The device according to claim 9, wherein:
said housing has a rectangular shape;
said housing has a depression being integrated into said front wall of said housing;
said depression being elongated along said axis extending between said front wall and said back wall of said housing;
said device includes a handle comprising a pair of outward members each being pivotally coupled to said first lateral wall of said housing and a central member extending between said pair of outward members wherein said central member is configured to be gripped for carrying said housing thereby enabling the parent to encumber their child with the inconvenience of carrying said housing;
said handset is removably fit-able into said depression for storing said handset; and
said communication unit is integrated into said handset.

11. The device according to claim 9, wherein:
each of said base and said housing has a rectangular shape;
said housing includes a key pad being disposed on said front wall of said housing;
said key pad being electrically coupled to said processing circuit for dialing a phone number;
said handset cradle comprises a pair of horns each extending away from said front wall of said housing; and
said pair of horns being spaced apart from each other to enable said earpiece of said handset to be positioned between said pair of horns for suspending said handset from said handset cradle.

12. The device according to claim 9, wherein:
each of said base and said housing has a rectangular shape;
said handset comprises a horn being configured to be gripped by the user for pointing said horn at one of the user's ears;
said speaker is positioned in said horn;
said handset cradle comprises a yoke extending away from said first lateral wall of said housing thereby enabling said horn to be suspended on said yoke;
said communication unit includes a horn being coupled to and extending forwardly from said front wall of said housing wherein said horn on said front wall is configured to be spoken into by the user;
said microphone is positioned in said horn on said front wall of said housing; and
said communication unit includes a hand crank being rotatably attached to said second lateral wall of said housing wherein said hand crank is configured to be rotated by the user.
